(19) United States
(12) Patent Application Publication
(10) Pub. No.: US 2023/0109473 A1
(43) Pub. Date: Apr. 6, 2023

(54) VEHICLE, ELECTRONIC APPARATUS, AND CONTROL METHOD THEREOF

(71) Applicants: Hyundai Motor Company, Seoul (KR); Kia Corporation, Seoul (KR)

(72) Inventors: Jihee Han, Seoul (KR); Junsik An, Seoul (KR); Jungwon Lee, Seoul (KR)

(21) Appl. No.: 18/063,473

(22) Filed: Dec. 8, 2022

(30) Foreign Application Priority Data
Jan. 17, 2021 (KR) 10-2021-0006536

(51) Int. Cl. G06T 7/55; H04N 23/698; H04N 23/90; G06T 7/33; G06T 7/80; H04N 5/265; B60W 50/06

(52) U.S. Cl. CPC G06T 7/55; H04N 23/698; H04N 23/90; G06T 7/33; G06T 7/80; H04N 5/265; B60W 50/06; G06T 2207/30252; B60W 2420/42; B60W 2554/80; B60W 2420/52

(57) ABSTRACT

Disclosed are a vehicle, an electronic apparatus, and a control method thereof. The vehicle includes a first image sensor provided to have a field of view toward a periphery of the vehicle to generate first image information, a second image sensor provided such that a field of view thereof overlaps the field of view of the first image sensor in a partial area to generate second image information, and a controller including a processor to process the image information, wherein the controller is provided to generate composite image information based on processing of the image information, and generate composite distance value data of the composite image information based on pre-stored first and second reliability data of each of the first and second image sensors and pre-stored first and second distance value data of each of the first and second image sensors.

### CROSS-REFERENCE TO RELATED APPLICATIONS

This application is based on and claims priority under 35 U.S.C. § 119 to Korean Patent Application No. 10-2021-0006536, filed on Jan. 17, 2021, in the Korean Intellectual Property Office, which application is incorporated by reference herein in its entirety.

### TECHNICAL FIELD

The disclosure relates to a vehicle, an electronic apparatus, and a control method thereof.

### BACKGROUND

Recently, as interest in autonomous vehicles has increased, research on sensors installed in autonomous vehicles is being actively conducted. As sensors installed in autonomous vehicles, there are image sensors, infrared sensors, radars, GPS, lidars, gyroscopes, etc., and the image sensor among them occupies an important position as a sensor that replaces the human eye.

Image stitching is an important technique in various computer vision applications that align a plurality of images captured from different viewing positions into a common coordinate area to create an image with a wide viewing angle. Recently, many commercial products using image stitching technology such as 360 degree panoramic cameras and surround view monitoring systems, and an image stitching apparatus and/or method for compositing multiple images, such as Adobe Photoshop Photomerge and Autostitch, are being developed.

However, when a plurality of images is composited into one by applying such image stitching technology, due to internal and/or external parameters of each image sensor, a distance value corresponding to a pixel of a composited image may not be reliably extracted.

### SUMMARY

The disclosure relates to a vehicle, an electronic apparatus, and a control method thereof, and more particularly, a vehicle, an electronic apparatus, and a control method thereof capable of calculating a reliability-based distance value of an image composited based on distance value data corresponding to pixels and actually measured distance value data based on camera calibration.

It is an aspect of the disclosure to provide a vehicle, an electronic apparatus, and a control method thereof capable of applying calibration-based distance estimation even to an image composited based on images obtained through different cameras.

Additional aspects of the disclosure will be set forth in part in the description which follows and, in part, will be obvious from the description, or may be learned by practice of the disclosure.

In accordance with an aspect of the disclosure, a vehicle includes a first image sensor provided to have a field of view toward a periphery of the vehicle to generate first image information, a second image sensor provided such that a field of view thereof overlaps the field of view of the first image sensor in a partial area to generate second image information, and a controller including a processor to process the image information, wherein the controller is provided to generate composite image information based on processing of the image information, and generate composite distance value data of the composite image information based on pre-stored first and second reliability data of each of the first and second image sensors and pre-stored first and second distance value data of each of the first and second image sensors.

The controller may be provided to impart a weight per pixel to the first and second distance value data based on the first and second reliability data corresponding to pixels in a superimposing area between the first image information and the second image information and generate composite distance value data based on the weight and the distance value data.

The controller may be provided to identify a corresponding point of the first image information and the second image information based on the processing of the image information and generate the composite image information based on the corresponding point and the image information.

The controller may be provided to identify an object around the vehicle by inputting the generated composite image information and identify and output a distance between the identified object and the vehicle based on the identified object and the composite distance value data.

The distance value data may be metadata about a distance value between a point corresponding to each pixel and the vehicle generated through camera calibration based on the image information.

The reliability data may be metadata generated based on the distance value data and actual distance value data between a point corresponding to each pixel and the vehicle.

The controller may be provided to identify a homography matrix parameter based on the corresponding point and generate the composite image information based on the identified parameter.

In accordance with another aspect of the disclosure, an electronic apparatus includes a first image sensor provided to generate first image information, a second image sensor provided such that a field of view thereof overlaps a field of view of the first image sensor in a partial area to generate second image information, and a controller including a processor to process the image information, wherein the controller is provided to generate composite image information based on processing of the image information and generate composite distance value data of the composite image information based on pre-stored first and second reliability data of each of the first and second image sensors and pre-stored first and second distance value data of each of the first and second image sensors.

In accordance with another aspect of the disclosure, a vehicle control method includes generating first image information, generating second image information, generating composite image information based on processing of the image information, and generating composite distance value data of the composite image information based on pre-stored first and second reliability data of each of the first and second image sensors and pre-stored first and second distance value data of each of the first and second image sensors.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram for explaining a configuration of a vehicle according to an embodiment;

FIG. 2 is a conceptual diagram for explaining a field of view of an image sensor of the vehicle according to an embodiment;

FIG. 3 is a conceptual diagram for explaining distance calculation through camera calibration according to an embodiment;

FIG. 4 is a conceptual diagram for explaining distance value data according to an embodiment;

FIGS. 5 and 6 are conceptual diagrams for explaining actual distance value data according to an embodiment;

FIG. 7 is a conceptual diagram for explaining reliability data according to an embodiment;

FIGS. 8 to 10 are conceptual diagrams for explaining generation of composite image information according to an embodiment;

FIG. 11 is a conceptual diagram for explaining the identification of a distance using composite image information and composite distance value data according to an embodiment; and

FIG. 12 is a flowchart for explaining a vehicle control method according to an embodiment.

### DETAILED DESCRIPTION OF ILLUSTRATIVE EMBODIMENTS

Throughout the specification, like reference numerals refer to like elements. This specification does not describe all the elements of the embodiments, and duplicative contents between general contents or embodiments in the technical field of the present disclosure will be omitted, The terms “portion,” “module,” “member,” and “block” as used herein, may be implemented as software or hardware, and according to embodiments, a plurality of “portions,” “modules,” “members,” or “blocks” may be implemented as a single component, or a single “portion,” “module,” “member,” or “block” may include a plurality of components.

Throughout the specification, when a portion is “connected” to another portion, this includes the case in which the portion is indirectly connected to the other portion, as well as the case in which the portion is directly connected to the other portion, and the indirect connection includes a connection through a wireless communication network.

When a part “includes” a certain component, it means that other components may be further included, rather than excluding other components, unless otherwise stated.

The terms first, second, etc. are used to distinguish one component from another component, and the component is not limited by the above-mentioned terms.

The singular expression includes the plural expression unless the context clearly dictates otherwise.

Identification numerals assigned to steps are used to identify the steps, the identification numerals do not indicate the order of the steps, and each step may be performed differently from the specified order unless the context clearly indicates a specific order.

A vehicle 10 according to an embodiment of the disclosure refers to a vehicle capable of traveling on a road or track. Hereinafter, for convenience of description, the vehicle 10 will be described using a four-wheeled vehicle as an example. However, an embodiment of the vehicle 10 is not limited thereto.

The vehicle 10 includes a vehicle body including an outer part of the vehicle 10 and a skeleton for loading people and/or cargo, such as, for example, an engine compartment, a trunk, a bumper, a roof, side panels, and a floor, and a chassis including essential devices necessary for the vehicle 10 to travel, such as, for example, an engine, a power transmission device, a steering device, and a brake device.

A general description of the vehicle body and chassis of the vehicle 1 will be omitted.

Hereinafter, a principle of action and embodiments of the disclosure will be described with reference to the accompanying drawings.

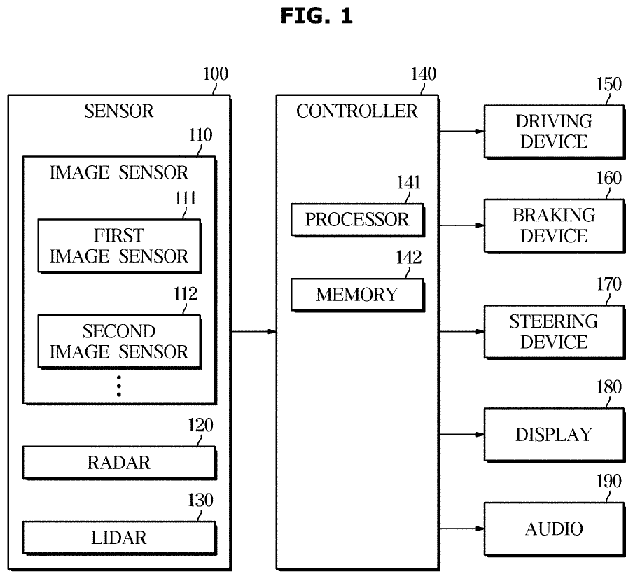

FIG. 1 is a block diagram for explaining a configuration of a vehicle according to an embodiment.

Referring to FIG. 1, a vehicle 10 may include a sensor 100, a controller 140, a driving device 150, a braking device 160, a steering device 170, a display 180, and an audio 190.

The sensor 100 may include an image sensor 110, a radar 120, and a lidar 130. Herein, the image sensor no may include at least one image sensor.

That is, the image sensor no may include a first image sensor 111, a second image sensor 112, a third image sensor (not shown), and the like. However, the number of image sensors no is not limited thereto. The image sensor no may be provided to have a field of view toward a periphery of the vehicle 10 to generate image information.

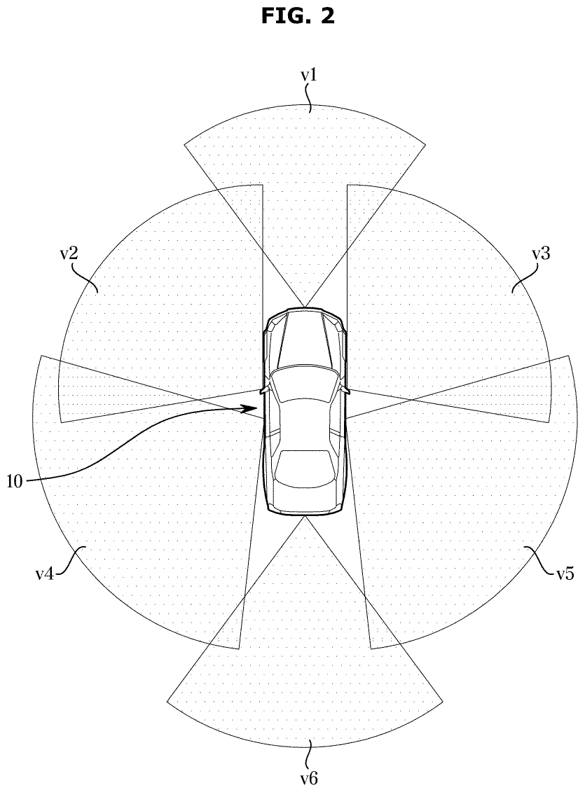

FIG. 2 is a conceptual diagram for explaining a field of view of an image sensor of the vehicle according to an embodiment.

The first image sensor 111 may have a field of view v1 facing the front of the vehicle 10 as illustrated in FIG. 2. The first image sensor 111 may be, for example, installed on a front windshield of the vehicle 10, but is not limited thereto.

As illustrated in FIG. 2, the second image sensor 112 may have a field of view v2 facing the left front of the vehicle 10, and the third image sensor (not shown) may have a field of view v3 facing the right front of the vehicle 10. The image sensors no may be arranged such that the fields of view overlap each other in a partial area. That is, as illustrated in FIG. 2, at least six of the image sensors no may be arranged such that the fields of view of the image sensors no adjacent to each other overlap each other in a partial area.

For example, the field of view v1 of the first image sensor 111 and the field of view v2 of the second image sensor 112 may overlap each other in a partial area, and the field of view v1 of the first image sensor 111 and the field of view v3 of the third image sensor (not shown) may overlap each other in a partial area.

The image sensors no may include a plurality of photodiodes to convert light into electrical signals, and the plurality of photodiodes may be arranged in a two-dimensional matrix. The image sensor no may generate image information including, for example, a two-dimensional image, and may generate image information including a plurality of two-dimensional images arranged over time. However, hereinafter, for convenience of description, description will be made based on a two-dimensional image corresponding to each of the image sensors no obtained from the plurality of image sensors no photographed at the same time. That is, for example, first image information generated by the first image sensor 111 and second image information generated by the second image sensor 112 may be two-dimensional images of the same time in which the fields of view overlap each other in a partial area.

A conventionally known sensor and/or a sensor to be developed in the future may be applied to the radar 120 and the lidar 130, and a general description thereof will be omitted.

At least one of the image sensor 110, the radar 120, and the lidar 130, and the controller 140 may integrally assist the driving of the vehicle 10. For example, the image sensor no, the radar 120, the lidar 130, and the controller 140 may integrally provide lane departure warning (LDW), lane keeping assist (LKA), high beam assist (HBA), autonomous emergency braking (AEB), traffic sign recognition (TSR), adaptive cruise control (ACC), blind spot detection (BSD), etc. However, the disclosure is not limited thereto.

The controller 140 may include a processor 141 and a memory 142. The memory 142 may be a non-transitory storage medium coupled to the processor with the non-transitory storage medium storing instructions to be executed by the processor.

The controller 140 may be electrically interconnected with components 110, 120, 130, 150, 160, 170, 180, and 190 of the vehicle 10. For example, the controller 140 may be a MCU itself of the vehicle 10 or may be connected to the MCU through a vehicle communication network NT or a hard wire. Herein, to be electrically interconnected may mean that mutual data communication is possible or power transmission/reception is possible.

The processor 141 may generate composite image information based on processing of the image information obtained from the image sensor no. That is, the processor 141 may generate composite image information based on the processing of at least two pieces of the image information obtained from the at least two image sensors no. More specifically, the processor 141 may generate composite image information based on processing of the image information obtained from at least two of the image sensors no adjacent to each other such that the fields of view overlap each other in a partial area.

More specifically, the processor 141 may identify a corresponding point between the respective image information based on the processing of the image information obtained from the at least two image sensors no provided such that the fields of view overlap each other, and may generate composite image information based on the corresponding point and the image information. The corresponding point may refer to, for example, a similar point between feature points derived from image information generated such that the fields of view overlap each other. Hereinafter, the image information generated such that the fields of view overlap each other in a partial area will be described based on, for example, the first image information generated from the first image sensor 111 and the second image information generated from the second image sensor 112. Therefore, it will be understood that this may also be applied to respective images generated from the image sensors adjacent to each other.

The processor 141 may extract a feature point. The processor 141 may detect feature points of the first image information and the second image information sequentially or in parallel.

The processor 141 may extract corners, edges, contours, line intersections, etc. as feature points from each of the first image information and the second image information using a SIFT algorithm, a HARRIS corner algorithm, a SUSAN algorithm, or the like. However, the disclosure is not limited thereto. Therefore, a conventionally known feature point extraction algorithm and/or a feature point extraction algorithm to be developed in the future may be applied.

The processor 141 may select corresponding points between the feature points of the first image information and the second image information. The processor 141 may determine one of the first image information and the second image information as reference image information, and select a feature point having a high degree of similarity in the remaining images as a c corresponding point, for each of the feature points of the reference image information. Hereinafter, for convenience of description, the first image information will be described as the reference image information.

Therefore, the processor 141 may estimate a homography matrix using a random sample consensus (RANSAC) or a locally optimized RANSAC (LO-RANSAC) algorithm based on the corresponding point.

The RANSAC algorithm includes a random sampling process of selecting n pairs of corresponding points at random in order to extract from a pair of images and estimate the homography matrix from among the pairs of corresponding points. However, the disclosure is not limited thereto. Therefore, a conventionally known corresponding point extraction algorithm and/or a corresponding point extraction algorithm to be developed in the future may be applied.

The homography matrix may include rotation information indicating at which angle of rotation to rotate, translation information indicating how much to move in x, y, and z directions, and scaling information indicating how much to change a size in the x, y, and z directions. That is, the homography matrix refers to a conversion relationship established between a point on an original plane and the projected corresponding points when one plane is projected onto another plane. That is, the homography matrix may refer to, for example, a parameter for conversion.

There are a forward mapping method and a backward mapping method as an image conversion method using the homography matrix, and when the forward mapping method is used, all pixels of a converted final image may not be filled as points before conversion are changed to points after conversion. Therefore, it may be more appropriate to use the backward mapping method to fill all pixels of the converted image. The backward mapping is a method of calculating, based on the homography matrix, a position where there is a pixel value to be referenced in an input image (herein, second image information) with respect to pixels of the reference image information (herein, first image information) when mapping between pixels in different image information, and performing image conversion by mapping pixel values of corresponding positions.

A method of generating the homography matrix is a conventionally known technique, and thus a detailed description thereof will be omitted.

Therefore, the processor 141 may derive feature points of the respective image information based on the processing of the first image information and the second image information, identify a corresponding point having a high degree of similarity between the feature points of the respective image information, and identify the homography matrix based on the corresponding point. Accordingly, the processor 141 may perform conversion of the second image information using the homography matrix.

When the respective image information is converted to a basic image, a void hole is generated at an outer portion of each image information, which means that the corresponding values generated in the homography conversion are absent. Such a void hole is an input that does not exist during machine learning, and it may be more appropriate to pad the void hole as a reflection mode for optimization of machine learning. Herein, the reflection mode may be an image conversion mode in which parts to be padded are filled with pixel values of adjacent areas so that void points are reduced for better learning.

Accordingly, the processor 141 may perform conversion of the second image information based on the processing of the first image information and the second image information, and generate composite image information by overlapping areas corresponding to the plurality of corresponding points based on the first image information and the converted second image information. Therefore, the overlapping areas of the first image information and the converted second image information of the composite image information may have a higher resolution. In addition, the processor 141 generates composite image information having a higher resolution in a wider field of view than the existing image information obtained from the single image sensor 110, thereby improving the learning ability of machine learning and improving the reliability of the output value.

The processor 141 may also generate the composite image information as described above based on the processing of image information obtained from the at least two image sensors no. Therefore, the processor 141 may generate composite image information, for example, based on the processing of image information obtained from the three image sensors no adjacent to each other. For example, in a case where the processor 141 generates composite image information based on the image information obtained from the first to third image sensors, it will be understood that the first to third image sensors may be applied even when the first and second image sensors are arranged such that the fields of view overlap and even when the second and third image sensors are arranged such that the fields of view overlap, without the need for all of the first to third image sensors to have fields of view so that the same partial area overlaps.

The processor 141 may perform a deep-learning algorithm for learning the surrounding object recognition model. Accordingly, the memory 142 may store the deep-learning algorithm. However, the disclosure is not limited thereto, and a conventionally known machine learning algorithm or a machine learning algorithm to be developed in the future may be applied, including unsupervised learning, reinforcement learning, and supervised learning.

For example, the surrounding object recognition model may refer to a surrounding object recognition model that is pre-learned and stored in the memory 142.

The surrounding object recognition model may refer to a machine learning model learned to output objects around the vehicle 10 with input of composite image information generated by the processor 141 as described above based on the processing of image information obtained by photographing the surroundings of the vehicle 10. More specifically, the processor 141 may output at least one pixel (coordinate) of an object existing in the composite image information by inputting the generated composite image information to the surrounding object recognition model.

Accordingly, the processor 141 may identify objects around the vehicle 10 by inputting the composite image information to the surrounding object recognition model. Herein, the objects may include, for example, other vehicles other than the vehicle 10 and/or pedestrians and/or cyclists and/or objects having a size larger than or equal to a predetermined size. However, the types of objects are not limited thereto.

The processor 141 may calculate distance value data between a point corresponding to a pixel of the image information and the vehicle 10 based on the processing of image information, which will be described later. That is, the distance value data may be metadata including a distance value corresponding to each pixel of image information generated by each image sensor. More specifically, the distance value data may include information on positions in longitudinal and lateral directions with respect to the image sensor no (or the vehicle 10) corresponding to each pixel.

Therefore, when the vehicle 10 includes a plurality of image sensors, the processor 141 may the calculate distance value data between a point corresponding to a pixel of each image information and the vehicle 10 (image sensor) based on the processing of image information obtained from each of the image sensors. As another embodiment, the distance value data may be data pre-stored in the memory 142.

The processor 141 may generate distance value data of composite image information based on the distance value data of each of the image sensors no and the pre-stored reliability data of each of the image sensors no. For example, when the image sensor no includes the first image sensor 111 and the second image sensor 112, the processor 141 may generate composite distance value data of composite image information based on the distance value data of the first image sensor 111 and the second image sensor 112 and the reliability data of the first image sensor 111 and the reliability data of the second image sensor 112, which are pre-stored.

Herein, the reliability data may refer to, for example, metadata generated based on the distance value data of the image sensor described above and actual distance value data from the vehicle 10 corresponding to each pixel of the image sensor. That is, the reliability data may refer to reliability data of a corresponding pixel of the distance value data, based on the distance value data corresponding to the image plane pixel of the image sensor based on the camera calibration, and based on the actual distance value data generated in a reference step of the vehicle 10, pre-stored, and actually measured between a point corresponding to a pixel of the image sensor and the image sensor (and/or the vehicle 10).

The processor 141 may generate composite image information based on the image information obtained from the at least two image sensors no. In this case, the processor 141 performs image conversion (mapping) of the image information except for the reference image information, and may map distance value data of image information excluding the reference image information together. For example, when the image sensor no includes the first image sensor 111 and the second image sensor 112, the processor 141 may set the first image information obtained from the first image sensor 111 to the reference image information. In this case, the processor 141 may calculate a homography matrix parameter based on the processing of the first image information and the second image information, and may map (image conversion) the second image information to the first image information based on the parameter.

Together with this, the processor 141 may map the distance value data corresponding to the pixel of the second image information to the distance value data corresponding to the pixel of the first image information based on the homography matrix parameter as well. In this case, areas in which the first image information and the second image information are superimposed and do not superimposed are generated. Herein, the non-superimposing area may refer to an area in which pixels of the second image information mapped to the first image information do not exist in a case where the reference image information is the first image information when the images of the first image information and the second image information are composited, and the superimposing area may refer to an area in which pixels of the second image information mapped to the first image information exist.

In the non-superimposing area, for example, distance value data (first distance value data) of a pixel corresponding to the first image information may be used as it is, or distance value data (second distance value data) of a pixel corresponding to the second image information may be used as it is. That is, when there is a pixel value (non-superimposing area) existing only in the first image information, the distance value data (first distance value data) of the pixel corresponding to the first image information is applied as composite distance value data of the corresponding pixel, and when there is a pixel value (non-superimposing area) existing only in the second image information, the distance value data (second distance value data) of the pixel corresponding to the second image information is applied as composite distance value data of the corresponding pixel.

On the other hand, in the superimposing area, for example, distance value data (first distance value data) of a pixel in a superimposing area corresponding to the first image information and distance value data (second distance value data) of a pixel in the superimposing area corresponding to the second image information may exist. In this case, the processor 141 may apply an intermediate value of the distance value data (first distance value data) of the first image information and the distance value data (second distance value data) of the second image information, which exist in the pixels of the superimposing area, as the composite distance value data. However, the disclosure is not limited thereto.

As another embodiment, the processor 141 may impart a weight based on a first reliability data corresponding to the distance value data (first distance value data) of the first image information, and may impart a weight based on a second reliability data corresponding to the distance value data (second distance value data) of the second image information. Herein, the sum of the imparted weights may be, for example, 1. That is, a weight may be imparted in proportion to sizes of the first reliability data and second reliability data. However, the disclosure is not limited thereto.

In this case, the processor 141 may generate composite distance value data based on the first distance value data, the second distance value data, and the weights. A third distance value data may be calculated based on Equation 1 below, for example.

D(x,y)=A*d1(x,y)+B*d2(x,y) [Equation 1]

Herein, D(y) ay refer to composite distance value data of a pixel (x, y), A may refer to the weight of the first distance value data imparted based on the first reliability data, B may refer to the weight of the second distance value data imparted based on the second reliability data, d1(x, y) may refer to the first distance value data of the pixel (x, and d2(x, y) may refer to the second distance value data of the pixel (x, y). However, the disclosure is not limited thereto.

As another embodiment, when three of the image sensors 110 are provided and the respective image information is converted based on one image information so that an area where three piece of image information are superimposed is generated, distance value data of the superimposing area may be calculated based on Equation 2 below.

D(x,y)=A=d1(x,y)+B*d2(x,y)+C*d3(x,y) [Equation 2]

Herein, C may refer to a weight of the third distance value data imparted based on a third reliability data, and d3(x, y) may refer to the third distance value data of the pixel (x, y).

More specifically, when the image sensor 110 includes the first image sensor 111 and the second image sensor 112 and a pixel in an superimposing area, the processor 141 may generate the first reliability data corresponding to the first image information and the second reliability data corresponding to the second image information, based on the first distance value data corresponding to the first image sensor in, the second distance value data corresponding to the second image information, a first actual distance value data corresponding to the first image sensor in, and a second actual distance value data corresponding to the second image sensor 112.

Accordingly, the processor 141 may impart a weight to a pixel in an area where the first image information and the second image information are superimposed based on the generated first reliability data and second reliability data. More specifically, the processor 141 may impart the weights to the first distance value data and the second distance value data based on a ratio of the first reliability data and the second reliability data of a specific pixel in the superimposing area. For example, when the first reliability data of a specific pixel is 0.5 and the second reliability data is 0.5, the weight of 0.5 may be imparted to the first distance value data and the second distance value data, respectively, and when the first reliability data of a specific pixel is 0.8 and the second reliability data is 0.4, the weight of 0.666 may be imparted to the first distance value data, and the weight of 0.333 may be imparted to the second distance value data. However, the disclosure is not limited thereto.

Likewise, it may be understood that, depending on the number of image sensors no, a weight may be imparted based on a ratio of each reliability data of each distance value data.

As another embodiment, the processor 141 may perform a self-diagnosis algorithm of the image sensor no. Accordingly, the processor 141 may identify a degree of normality of the image sensor 110. The processor 141 may identify the degree of normality corresponding to each of the plurality of image sensors no by performing the self-diagnosis algorithm for each of the plurality of image sensors no. Herein, the degree of normality may be, for example, a numerical value indicating whether the image sensor no may operate normally. On the other hand, there is no limitation on the self-diagnosis algorithm. In this case, the processor 141 may impart the weights to pixels in the superimposing area based on the degree of normality of each of the image sensors, the distance value data of each of the image sensors, and the reliability data of each of the image sensors.

It may be understood that for example, when the degree of normality of the first image sensor 111 is 80%, the degree of normality of the second image sensor 112 is 100%, the first reliability data of a specific pixel in the superimposing area is 0.5 and the second reliability data is 0.5, the processor 141 may impart the weight to the first distance value data to be less than 0.5 and the weight to the second reliability data to be greater than 0.5.

Accordingly, the processor 141 may generate composite distance value data of the superimposing area and non-superimposing area of the composite image information, and may, based on this, identify a distance value (distance between the vehicle 10 and a point corresponding to the pixel) corresponding to the pixel of the composite image information.

The processor 141 may also identify distance value data corresponding to a pixel of an image plane based on the generated composite image information and the composite distance value data.

More specifically, the processor 141 may identify a distance value of at least one pixel based on the at least one pixel and the composite distance value data output by inputting the composite image information to the surrounding object recognition model. Herein, the distance value may include, for example, a longitudinal distance and/or a lateral distance between objects from the vehicle 10 and/or the image sensor 110.

On the other hand, a known technology applied based on image information and distance value data and/or a technology to be developed in the future may be applied. It may be understood that the output of a speed value of the reference point may be implemented based on the composite image information and the composite distance value data by, for example, identifying the reference point of image information and estimating an amount of position change between a previous frame and a current frame using a Kalman filter. Because the composite image information may provide a higher resolution than image information obtained by a single image sensor, an additional effect, such as an increase in accuracy and/or reliability resulting from this effect, may be easily predicted by those skilled in the art.

The memory 142 may store information received from the sensor 100, processing results of the processor 141, preset values, and/or a variety of information (for example, distance value data and/or reliability data of each of the image sensors no disposed in the vehicle 10), and the like. Necessary information among the information received from the sensor 100 is stored in the memory 142 and may be stored in the form of a database.

The memory 142 may store a program for performing the above-described operation and an operation to be described later, and the processor 141 may execute the stored program. When a plurality of the memories 142 and the processors 141 is provided, they may be integrated into one chip or may be provided in physically separate locations. The memory 142 may include a volatile memory for temporarily storing data, such as a static random access memory (S-RAM) and a dynamic random access memory (D-RAM). The memory 142 may also include a non-volatile memory for long-term storage of control programs and control data, such as a read only memory (ROM), an erasable programmable read only memory (EPROM), and an electrically erasable programmable read only memory (EEPROM). The processor 141 may include various logic circuits and arithmetic circuits, process data according to a program provided from the memory 142, and generate a control signal depending on the processing result.

The real world is composed of three dimensions, but when it is photographed by the image sensor 110, it is projected as a two-dimensional image. In this case, actual three-dimensional position coordinates are determined by a position and orientation of the image sensor no at the time of taking the image when geometrically calculated where it is located on the image. However, because an actual image is affected by internal factors such as used lens and a distance to an object, the three-dimensional position coordinates may be accurately calculated only in a case where these internal factors are removed when a position projected on the image is obtained or when three-dimensional spatial coordinates are restored from the image coordinates. A process of obtaining parameter values of these internal factors is referred to as camera calibration.

The camera calibration is largely divided into an internal parameter calibration process of identifying mechanical characteristics of the image sensor no itself and an external parameter calibration process of identifying external characteristics of the device such as an installation position and posture information (direction angle) of the image sensor no. The internal parameters of the image sensor 110 include a focal length, a principal point, a lens distortion coefficient, and the like, and the external parameters of the image sensor no include three-dimensional position information (installation position of the image sensor no such as x, y, z, etc.) of the image sensor no based on a reference coordinate system (world coordinate system) and posture information (direction angles such as pan, tilt, and roll). Because the camera calibration is a known technique, a detailed description thereof will be omitted.

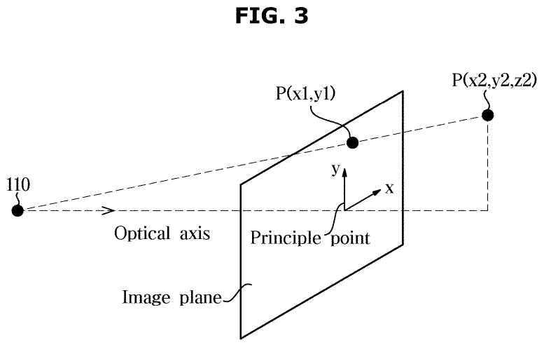

FIG. 3 is a conceptual diagram for explaining distance calculation through camera calibration according to an embodiment.

Referring to FIG. 3, a distance value z2 between an object (x2, y2, z2) on the ground corresponding to a pixel (x1, y1) and the image sensor no may be calculated based on a distance between the pixel (x1, y1) and the principal point on the image plane and an optical axis of the image sensor no. Herein, the object on the ground may be, for example, a single point, and may refer to a point in contact with the ground in the case of an object having a volume.

More specifically, because the object on the ground corresponds to the pixel (x1, y1) on the image plane, a ratio of a normalized distance between the image sensor 110 and the principal point and the distance between the principal point and the pixel (x1, y1) is the same as a ratio of a distance between the image sensor 110 and an optical axis corresponding to the object on the ground and a distance between the optical axis and the object on the ground. In addition, because the object exists on the ground, and a distance between the ground and the image sensor 110 may be obtained based on the camera calibration, the distance value between the object (X2, y2, z2) corresponding to the pixel (x1, y1) and the image sensor 110 may be calculated. However, the disclosure is not limited thereto. Because a method of calculating a distance value between an image sensor and an object corresponding to a pixel on an image plane based on camera calibration is a known technique, a detailed description thereof will be omitted.

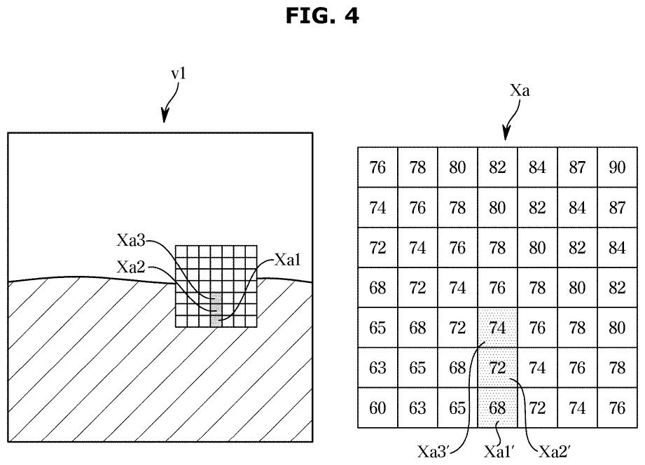

Hereinafter, distance value data, actual distance value data, and reliability data will be described with reference to FIGS. 4 to 7. FIGS. 4 to 7 are illustrated based on the image information obtained based on the first image sensor 111 for convenience of explanation, but is not limited thereto. That is, FIGS. 4 to 7 may be conceptual diagrams regarding data applicable to each of the image sensors no including n image sensors.

FIG. 4 is a conceptual diagram for explaining distance value data according to an embodiment.

Referring to FIG. 4, an image plane corresponding to the field of view v1 of the one image sensor no and distance value data Xa corresponding thereto may be understood. That is, the distance value data may refer to distance value data (Xa1′, Xa2′, Xa3′ . . . ) corresponding to pixels (Xa1, Xa2, Xa3 . . . ), respectively, identified based on distances between the pixels (Xa1, Xa2, Xa3 . . . ) and the principal point on the image plane and the optical axis of the image sensor 110.

That is, the distance value data may be metadata about a distance value from the image sensor no corresponding to each pixel on the image plane generated by the image information generated by the image sensor no through the camera calibration.

Referring to FIG. 4, the distance value data may include the distance values (Xa1′, Xa2′, Xa3′ . . . ) corresponding to the respective pixels (Xa1, Xa2, Xa3 . . . ). Accordingly, one image sensor no may pre-store distance values data including the metadata about the distance values corresponding to the respective pixels or pre-store the distance values data in the memory 142. However, the disclosure is not limited thereto. As another embodiment, the distance value data may be data calculated based on processing of the image information received from the image sensor no by the controller 140.

That is, as illustrated in FIG. 4, the controller 140 may identify a distance value corresponding to a pixel on an image plane of the image information through the camera calibration and generates distance value data, based on processing of at least one image information obtained from the image sensor 110. However, the disclosure is not limited thereto.

As illustrated in FIG. 4, the distance value data Xa represents only one numerical value (distance) corresponding to a pixel, but is not limited thereto, and as another embodiment, information on a longitudinal position and a lateral position with respect to the vehicle 10 and/or the image sensor 110 corresponding to the pixel may be further included.

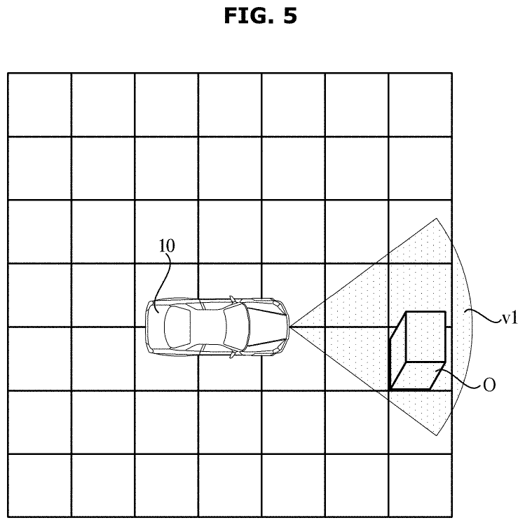

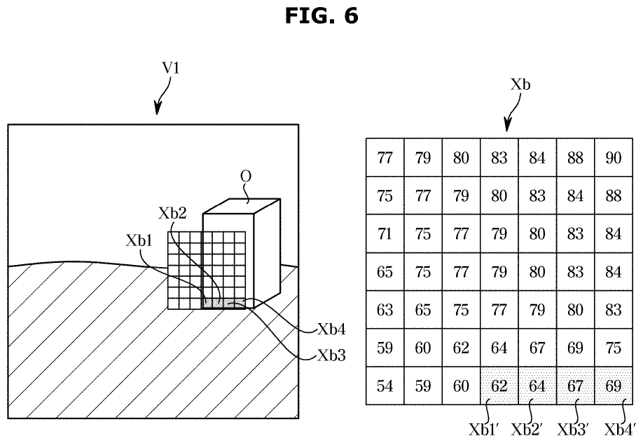

FIGS. 5 and 6 are conceptual diagrams for explaining actual distance value data according to an embodiment.

Referring to FIGS. 5 and 6, the actual distance value data may be data generated in the reference step after a manufacturing process of the vehicle 10. For example, when the actual distance value data of the first image sensor 111 is generated, a vertical object O may be constructed for each predetermined area in the field of view v1 of the first image sensor 111 of the vehicle 10. That is, the actual distance value data may be metadata generated by identifying a pixel at a point where the vertical object O is in contact with the ground and actually measuring a distance between the vehicle 10 and the vertical object O.

More specifically, referring to FIG. 6, contact pixels (Xb1, Xb2, Xb3, Xb4 . . . ) between the observed object O of the first image sensor 111 and the ground are identified, and distances between the points corresponding to the contact pixels and the vehicle 10 are actually measured so that distance values (Xb1′, Xb2′, Xb3′, Xb4′ . . . ) corresponding to the pixels correspond thereto, thereby generating actual distance value data Xb. However, the disclosure is not limited thereto.

As another embodiment, the actual distance value data Xb may be, for example, metadata generated by measuring a distance of a point corresponding to a pixel of image information, based on the radar 120 and/or lidar 130.

As illustrated in FIG. 6, the actual distance value data Xb represents only one numerical value (distance) corresponding to the pixel, but is not limited thereto, and as another embodiment, may further include information on the longitudinal position and the lateral position with respect to the vehicle 10 and/or the image sensor no corresponding to the pixel.

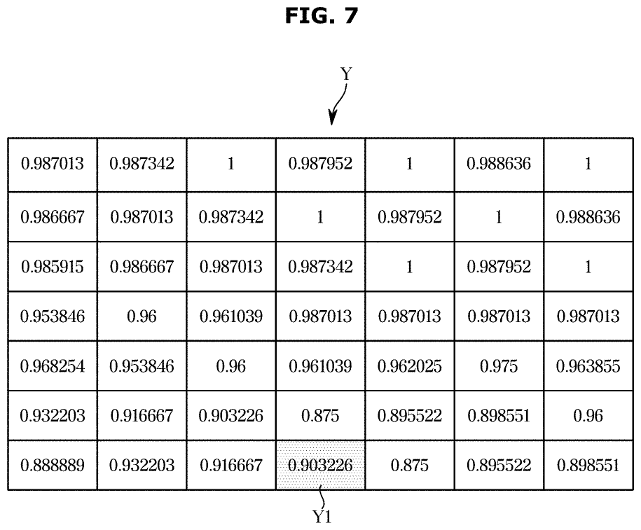

FIG. 7 is a conceptual diagram for explaining reliability data according to an embodiment.

Referring to FIG. 7, reliability data Y may be generated based on distance value data Xa of the image information obtained from the image sensor no and the actually measured distance value data Xb.

More specifically, the controller 140 may generate the reliability data Y based on the distance value data (or the pre-stored distance value data of the image sensor) and the actually measured distance value data Xb obtained based on processing of the image information through the camera calibration. The reliability data may be generated, for example, based on Equation 3 below.

$$R ( x , y ) = 1 - \frac{\vert Xa ( x , y ) - X b ( x , y ) \vert}{Xb ( x , y )} \qquad [ Equation 3 ]$$

Herein, R(x, y) may refer to reliability data corresponding to the pixel (x, y), Xa(x, y) may refer to distance value data (or distance value data generated by the controller) corresponding to the image sensor, and Xb(x, y) may refer to the actually measured distance value data.

For example, referring to FIGS. 4, 6 and 7, because the pixel of Xa3′ and the pixel of Xb1′ are the same, the distance value data of the pixel of Xa3′ of the distance value data Xa is 68, and the distance value data of the pixel of Xb1′ of the actual distance value data Xb is 62, it may be understood that the reliability data corresponding to the corresponding pixel may be calculated as about 0.903226.

As illustrated in FIG. 7, the reliability data Y represents only one numerical value (reliability) corresponding to the pixel, but is not limited thereto, and as another embodiment, may further include numerical values (reliability) about the longitudinal position and the lateral position with respect to the vehicle 10 and/or the image sensor 110 corresponding to the pixel.

In the above description, it has been exemplified that the composite image information and the composite distance value data of the vehicle 10 including the two and three image sensors 110 are generated. However, the number of image sensors 110 is not limited thereto, and the at least four image sensors 110 may be applied.

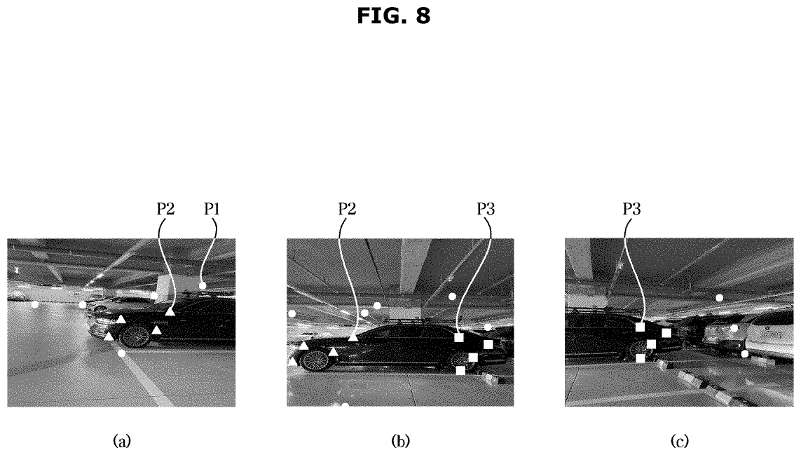

FIGS. 8 to 10 are conceptual diagrams for explaining generation of composite image information according to an embodiment.

Referring to FIG. 8, the controller 140 may detect a feature point P1 of each image information based on the processing of the image information (first image information, second image information, and third image information) obtained from the first to third image sensors 110. Herein, the feature point P1 may refer to a point detected using, for example, the SIFT algorithm, the HARRIS corner algorithm, the SUSAN algorithm, or the like.

More specifically, the first image information obtained from the first image sensor 111 may have the field of view v1 as illustrated in FIG. 8B, the second image information obtained from the second image sensor 112 may have the field of view v2 as illustrated in FIG. 8A, and the third image information obtained from the third image sensor (not shown) may have the field of view v3 as illustrated in FIG. 8C.

Accordingly, the controller 140 may set the second image information as the reference image information, and may identify a feature point having a high degree of similarity to the first image information and the third image information as a corresponding point for each of the feature points P1 of the second image information. More specifically, the controller 140 may identify a corresponding point P2 having a high degree of similarity between the feature points P1 of the second image information and the first image information, and may identify a corresponding point P3 having a high degree of similarity between the feature points P1 of the second image information and the third image information.

Accordingly, the controller 140 may identify a parameter of the homography matrix based on the corresponding point P2 between the first image information and the second image information. In this case, the controller 140 may perform image conversion of information on each pixel of the first image information into second image information, which is reference image information, based on the parameter of the homography matrix. The controller 140 may also identify a parameter of a homography matrix based on the corresponding point P3 between the second image information and the third image information, and may, based on this, perform image conversion of the information on each pixel of the third image information into the second image information, which is the reference image information. However, the disclosure is not limited thereto, and the homography matrix parameter is applied without deriving a feature point and a corresponding point for each image information based on, for example, a pre-stored homography matrix parameter, so that the first image information and the third image information may be converted. Herein, the pre-stored homography matrix parameter may be, for example, a pre-stored parameter obtained in the reference step of the vehicle 10.

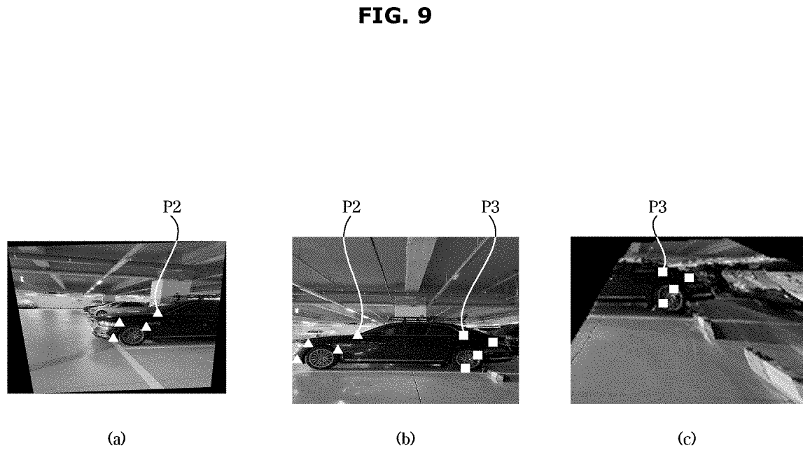

Referring to FIG. 9, the controller 140 does not perform conversion for the second image information, which is the reference image information, and may understand image information obtained by mapping (converting) the first image information and the third image information based on the pixels of the second image information which is the reference image information.

In this case, the controller 140 may map the first and third distance value data to pixels of the second image information corresponding to the pixels of the first image information and the third image information, based on the parameter of the homography matrix used when the first image information and the third image information are converted. Accordingly, the controller 140 may generate the first and third distance value data corresponding to the first image information and the third image information based on the pixels of the second image information which is the reference image information. However, the disclosure is not limited thereto. For example, when the pixel of the first image information is (M, N) and the pixel after conversion is (m, n), it may be understood that the distance value data corresponding to the pixel (M, N) may be equally applied to the pixel (m, n) after conversion.

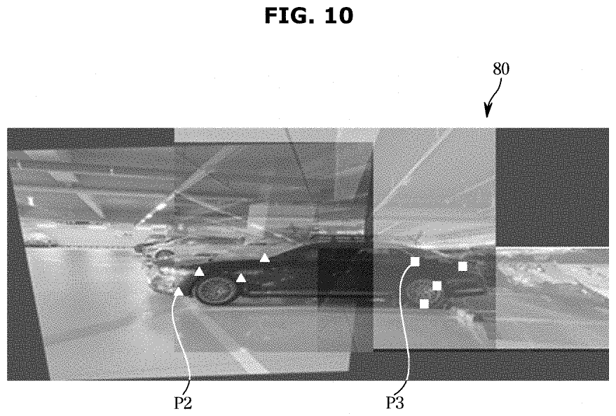

Referring to FIG. 10, the controller 140 may generate composite image information 80 by superimposing the first image information and the third image information after conversion based on the feature points P2 and P3. In this case, a weight is imparted to the composite distance value data in the area where the first image information and the second image information are superimposed as described above, and the composite image information may be further generated based on this, and in a non-superimposing area, distance value data corresponding to each image information may be applied as the composite distance value data. However, the disclosure is not limited thereto.

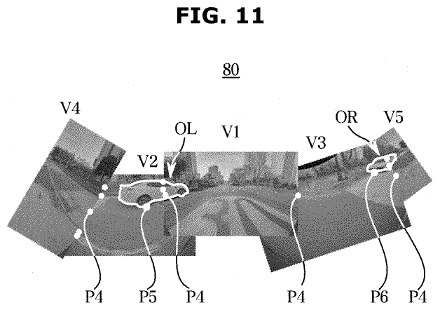

FIG. 11 is a conceptual diagram for explaining the identification of a distance using composite image information and composite distance value data according to an embodiment.

Referring to FIG. 1i, the controller 140 may generate the composite image information 80 based on processing of first to fifth image information V1 to V5 obtained from the first image sensor 111, the second image sensor 112, the third image sensor (not shown), a fourth image sensor (not shown), and a fifth image sensor (not shown). More specifically, the controller 140 derives a feature point of each image information, estimates a homography matrix parameter based on a corresponding point P4, which is a similar feature point in the overlapping area, and performs image conversion and overlaps based on the reference image information (first image information in the drawing), thereby generating the composite image information 80.

The controller 140 inputs the composite image information 80 to the surrounding object recognition model and outputs at least one pixel P5 or P6 of objects OL and OR, thereby identifying the objects OL and OR. Accordingly, the controller 140 may identify a distance between the objects OL and OR and the vehicle 10 based on the pixels P5 and P6 of the objects OL and OR and the composite distance value data. However, the disclosure is not limited thereto.

The controller 140 may reduce a post-processing cost required to composite an output of a final object using the recognition result of each of the plurality of image sensors due to the above-described operations and configurations.

In addition, by compositing a plurality pieces of image information, the controller 140 may reduce output time synchronization between the plurality pieces of image information separately obtained from the image sensors and/or reduce a cost of the image memory.

An electronic apparatus (not shown) according to an embodiment of the disclosure may include the image sensor no and the controller 140 described above. Accordingly, the electronic apparatus (not shown) may generate composite image information and composite distance value data based on the processing of the image information obtained from the image sensor 110, and thus may identify the distance between the object and the image sensor.

At least one component may be added or deleted depending on the performance of the above-described components of the electronic apparatus (not shown). In addition, it will be readily understood by those of ordinary skill in the art that the mutual positions of the components may be changed depending on the performance or structure of the system.

Some components of the electronic apparatus (not shown) may be software and/or hardware components such as a field programmable gate array (FPGA) and an application specific integrated circuit (ASIC).

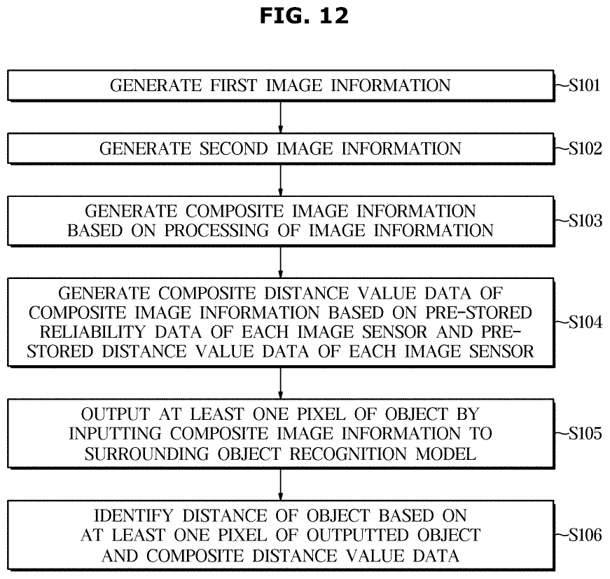

FIG. 12 is a flowchart for explaining a vehicle control method according to an embodiment.

A vehicle 10 control method may be performed by the vehicle 10 described above. Therefore, even though omitted below, the description of the vehicle 10 may be equally applied to the description of the vehicle control method.

Referring to FIG. 12, the vehicle 10 may generate the first image information (S101).

The vehicle 10 may also generate the second image information (S102).

The vehicle 10 may also generate composite image information based on the processing of the image information (S103).

The vehicle 10 may also generate composite distance value data of the composite image information based on the pre-stored reliability data of each of the image sensors no and the pre-stored distance value data of each of the image sensors no (S104).

The vehicle 10 may also output at least one pixel of an object by inputting the composite image information to the surrounding object recognition model (S105).

The vehicle 10 may also identify a distance of the object based on at least one pixel of the outputted object and the composite distance value data (S106).

As is apparent from the above, a vehicle, an electronic apparatus, and a control method thereof according to an embodiment can reduce post-processing cost and output time synchronization burden of each image information by applying calibration-based distance estimation even to an image composited based on images obtained through different cameras.

The disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

The embodiments disclosed with reference to the accompanying drawings have been described above. It will be understood by those skilled in the art that various changes in form and details may be made therein without departing from the spirit and scope of the disclosure as defined by the appended claims. The disclosed embodiments are illustrative and should not be construed as limiting.

What is claimed is:

1. A vehicle comprising:
a first image sensor configured to have a first field of view toward a periphery of the vehicle to generate first image information;
a second image sensor configured to have a second field of view that overlaps the first field of view in a partial area to generate second image information; and
a controller comprising a processor and a non-transitory storage medium coupled to the processor, the processor configured to process the first and second image information, the non-transitory storage medium configured to store instructions that, when executed by the processor, cause the controller to:
generate composite image information based on processing of the first and second image information, and
generate composite distance value data of the composite image information based on pre-stored first and second reliability data of each of the first image sensor and the second image sensor and pre-stored first and second distance value data of each of the first image sensor and the second image sensor.

2. The vehicle according to claim 1, wherein the controller is provided to:
impart a weight per pixel to the first and second distance value data based on the first and second reliability data corresponding to pixels in a superimposing area between the first image information and the second image information, and
generate composite distance value data based on the weight and the distance value data.

3. The vehicle according to claim 1, wherein the controller is provided to:
identify a corresponding point of the first image information and the second image information based on the processing of the image information, and
generate the composite image information based on the corresponding point and the image information.

4. The vehicle according to claim 3, wherein the controller is provided to:
identify an object around the vehicle by inputting the generated composite image information, and
identify and output a distance between the identified object and the vehicle based on the identified object and the composite distance value data.

5. The vehicle according to claim 1, wherein the distance value data is metadata about a distance value between a point corresponding to each pixel and the vehicle generated through camera calibration based on the image information.

6. The vehicle according to claim 5, wherein the reliability data is metadata generated based on the distance value data and actual distance value data between a point corresponding to each pixel and the vehicle.

7. The vehicle according to claim 3, wherein the controller is provided to:
identify a homography matrix parameter based on the corresponding point, and
generate the composite image information based on the identified parameter.

8. An electronic apparatus comprising:
a first image sensor configured to generate first image information;
a second image sensor configured such that a field of view thereof overlaps a field of view of the first image sensor in a partial area to generate second image information; and
a controller comprising a processor and a non-transitory storage medium coupled to the processor, the processor configured to process the first and second image information, the non-transitory storage medium configured to store instructions that, when executed by the processor, cause the controller to:
generate composite image information based on processing of the first and second image information, and
generate composite distance value data of the composite image information based on pre-stored first and second reliability data of each of the first image sensor and the second image sensor and pre-stored first and second distance value data of each of the first image sensor and the second image sensor.

9. The electronic apparatus according to claim 8, wherein the controller is provided to:
impart a weight per pixel to the first and second distance value data based on the first and second reliability data corresponding to pixels in a superimposing area between the first image information and the second image information, and
generate composite distance value data based on the weight and the distance value data.

10. The electronic apparatus according to claim 8, wherein the controller is provided to:
identify a corresponding point of the first image information and the second image information based on the processing of the image information, and
generate the composite image information based on the corresponding point and the image information.

11. The electronic apparatus according to claim 10, wherein the controller is provided to:
identify an object around the vehicle by inputting the generated composite image information, and
identify and output a distance between the identified object and the vehicle based on the identified object and the composite distance value data.

12. The electronic apparatus according to claim 8, wherein the distance value data is metadata about a distance value between a point corresponding to each pixel and the vehicle generated through camera calibration based on the image information.

13. The electronic apparatus according to claim 12, wherein the reliability data is metadata generated based on the distance value data and actual distance value data between a point corresponding to each pixel and the vehicle.

14. The electronic apparatus according to claim 10, wherein the controller is provided to:
identify a homography matrix parameter based on the corresponding point, and generate the composite image information based on the identified parameter.

15. A vehicle control method comprising:
generating, by a first image sensor, first image information;
generating, by a second image sensor, second image information;
generating, by a controller, composite image information based on processing of the first and second image information; and
generating, by the controller, composite distance value data of the composite image information based on pre-stored first and second reliability data of each of the first image sensor and the second image sensor and pre-stored first and second distance value data of each of the first image sensor and the second image sensor.

16. The vehicle control method according to claim 15, further comprising
imparting, by the controller, a weight per pixel to the first and second distance value data based on the first and second reliability data corresponding to pixels in a superimposing area between the first image information and the second image information,
wherein the generating, by the controller, of the composite distance value data comprises generating, by the controller, composite distance value data based on the weight and the distance value data.

17. The vehicle control method according to claim 15, wherein the generating, by the controller, of the composite image information comprises identifying, by the controller, a corresponding point of the first image information and the second image information based on the processing of the image information, and generating, by the controller, the composite image information based on the corresponding point and the image information.

18. The vehicle control method according to claim 17, further comprising:
identifying, by the controller, an object around the vehicle by inputting the generated composite image information; and
identifying and outputting, by the controller, a distance between the identified object and the vehicle based on the identified object and the composite distance value data.

19. The vehicle control method according to claim 15, wherein the distance value data is metadata about a distance value between a point corresponding to each pixel and the vehicle generated through camera calibration based on the image information.

20. A computer-readable recording medium in which a program capable of executing the vehicle control method according to claim 15 is recorded.
